(19) United States
(12) Patent Application Publication
(10) Pub. No.: US 2026/0208199 A1
(43) Pub. Date: Jul. 23, 2026

(54) FLOW RATE CONTROL MECHANISM OF RICE MILLING MACHINE

(71) Applicant: SATAKE CORPORATION, Chiyoda-ku, Tokyo (JP)

(72) Inventors: Sumio TAGAWA, Chiyoda-ku, Tokyo (JP); Koji KAWAKAMI, Chiyoda-ku, Tokyo (JP)

(73) Assignee: SATAKE CORPORATION, Chiyoda-ku, Tokyo (JP)

(21) Appl. No.: 19/140,029

(22) PCT Filed: Dec. 22, 2023
(86) PCT No.: PCT/JP2023/046146

§ 371 Date: Jun. 17, 2025

(30) Foreign Application Priority Data
Jan. 13, 2023 (JP) 2023-004012

(51) Int. Cl. B02B 7/02; B02B 3/00; G05D 7/06

(52) U.S. Cl. CPC B02B 7/02; B02B 3/00; G05D 7/0611

(57) ABSTRACT

An embodiment includes: a rice milling unit configured to mill rice; and a rice milling tank provided above the rice milling unit and configured to store rice, the rice milling tank includes a flow rate control valve configured to adjust a supply amount of rice to the rice milling unit by being moved vertically in the rice milling tank, and an optical flow rate detection unit provided to a wall of the rice milling tank and configured to determine a flow rate of rice flowing between the wall and the flow rate control valve.

### TECHNICAL FIELD

The present invention relates to a flow rate control mechanism of a rice milling machine that can control and adjust a flow rate of grains supplied to a rice milling unit of the rice milling machine.

### BACKGROUND ART

As a conventional art, Patent Literature 1 discloses a technique in which grain detection sensors are provided at five portions vertically in a grain polishing chamber in order to maintain constant the amount of rice in the grain polishing chamber by flow rate control with a regulating valve. Further, Patent Literature 2 discloses a technique that determines the flow rate of rice as a load current value of a conveyance machine motor M1 and adjusts a grain feed valve to quantify and control the flow rate of rice supplied to the grain polishing chamber when the load current value exceeds a set current value. Furthermore, Patent Literature 3 discloses a technique in which a grain feed device that supplies rice to a grain polishing chamber has an opening/closing function and a flow rate adjustment function performed by a rotary valve.

### Citation List

### Patent Literature

Patent Literature 1: Japanese Patent Application Laid-Open No. H6-102159
Patent Literature 2: Japanese Patent Application Laid-Open No. H6-047295
Patent Literature 3: Japanese Patent Application Laid-Open No. H7-308593

### SUMMARY OF INVENTION

### Technical Problem

In the technique disclosed above in Patent Literature 1, however, since the regulating valve is controlled so that the grain polishing chamber is always filled with a constant quantity of grains by using grain detection sensors, the quantity of grains repeatedly increases and decreases among respective grain detection sensors, which may cause unevenness in rice milling and a reduction in rice milling efficiency.

Further, to mill rice efficiently, although it is required for the pressure inside the grain polishing chamber applied by a resistance lid, the circumferential speed of a grindstone, and the flow rate and the discharge amount of rice in the rice milling machine to be operated and adjusted in accordance with the degree of rice milling, it is difficult to mill rice efficiently by the method to merely manage the amount of rice filled in the grain polishing chamber as illustrated in Patent Literatures 1 to 3 described above.

In view of the above problems, the present invention intends to provide a flow rate control mechanism of a rice milling machine that can mill rice more effectively than in the conventional art.

### Solution to Problem

An embodiment of the invention according to (1) is a flow rate control mechanism of a rice milling machine, and the flow rate control mechanism includes: a rice milling unit configured to mill rice; and a rice milling tank provided above the rice milling unit and configured to store rice, the rice milling tank includes a flow rate control valve configured to adjust a supply amount of rice to the rice milling unit by being moved vertically in the rice milling tank, and an optical flow rate detection unit provided to a wall of the rice milling tank and configured to determine a flow rate of rice flowing between the wall and the flow rate control valve.

An embodiment of the invention according to (2) further includes a control unit configured to control the flow rate control valve, and the control unit is configured to move the flow rate control valve upward or downward based on detection data from the optical flow rate detection unit.

Furthermore, in an embodiment of the invention according to (3), the flow rate control valve includes a conical part and a columnar part formed below the conical part, and the optical flow rate detection unit determines a flow rate of rice flowing between the wall of the rice milling tank and the columnar part of the flow rate control valve.

Furthermore, in an embodiment of the invention according to (4), (5), the optical flow rate detection unit is configured to output a displacement amount and a displacement direction of rice from continuous images of the rice acquired by using a vertical cavity surface emitting laser.

Furthermore, in an embodiment of the invention according to (6), (7), the optical flow rate detection unit is configured to output a displacement amount and a displacement direction of rice from continuous images of the rice acquired by using a TOF camera.

### Advantageous Effects of Invention

In the embodiment of the present invention, an optical flow rate detection unit that can determine the flow rate of rice flowing between a wall of a rice milling tank and a flow rate control valve is provided to the wall of the rice milling tank. Accordingly, the flow speed of rice flowing down along the inner surface of the rice milling tank can be determined to calculate the flow rate thereof, and suitable control of the flow rate of rice can be performed via the vertical motion of the flow rate control valve. That is, the optical flow rate detection unit that can directly, optically determine the flow rate of rice is formed in the rice milling tank immediately upstream of the rice milling unit, and this improves the accuracy in monitoring the flow rate of rice and enables fine adjustment of the flow rate of rice by feedback control based on determined data. It is thus possible to improve the rice milling efficiency and the rice milling quality.

The conventional art attempts to adjust the flow rate of rice by the degree of the opening of the regulating valve. In reality, however, the flow rate of rice changes because, in accordance with the progress of pearling in the rice milling unit, the shape of rice or the friction resistance changes due to a change in the starch composition on the surface of rice. Even when the degree of the opening of the regulating valve is maintained constant, the flow rate of rice changes, and this makes it difficult to adjust the flow rate thereof. In contrast, according to the embodiment of the present invention, the flow rate of rice flowing down along the inner surface of the rice milling tank is determined and multiplied by the sectional area of the flowing range, and thereby the flow rate of rice is calculated. Thus, the flow rate of rice in this case is a volume density, and this enables suitable adjustment of the flow rate of rice flowing into the rice milling unit without being affected by the bulk specific gravity.

### BRIEF DESCRIPTION OF DRAWINGS

FIG. 1 is a schematic configuration diagram of a rice milling machine of the present embodiment.

FIG. 2 is sectional views of the rice milling tank of the present embodiment in planar view and side view.

FIG. 3 is an illustration diagram illustrating a detection configuration with an optical image system of the present embodiment.

FIG. 4 is a flow diagram illustrating the detection configuration with the optical image system of the present embodiment.

FIG. 5 is an illustration diagram illustrating a detection configuration with a TOF camera system of another embodiment.

FIG. 6 is a flow diagram illustrating the detection configuration with the TOF camera system of another embodiment.

FIG. 7A is a sectional view of the rice milling tank illustrating a motion form of a flow rate control valve of the present embodiment.

FIG. 7B is a sectional view of the rice milling tank illustrating the motion form of the flow rate control valve of the present embodiment.

FIG. 7C is a sectional view of the rice milling tank illustrating the motion form of the flow rate control valve of the present embodiment.

FIG. 8 is a flow diagram illustrating a control configuration of a flow rate control mechanism of the present embodiment.

FIG. 9A is a sectional view of a rice milling tank illustrating a motion form of a flow rate control valve of another embodiment.

FIG. 9B is a sectional view of the rice milling tank illustrating the motion form of the flow rate control valve of another embodiment.

FIG. 9C is a sectional view of the rice milling tank illustrating the motion form of the flow rate control valve of another embodiment.

FIG. 10 is a sectional view of the rice milling tank illustrating an installable range of an optical flow rate detection unit of another embodiment.

### DESCRIPTION OF EMBODIMENTS

One embodiment of a flow rate control mechanism of a rice milling machine of the present invention will be described below with reference to the drawings.

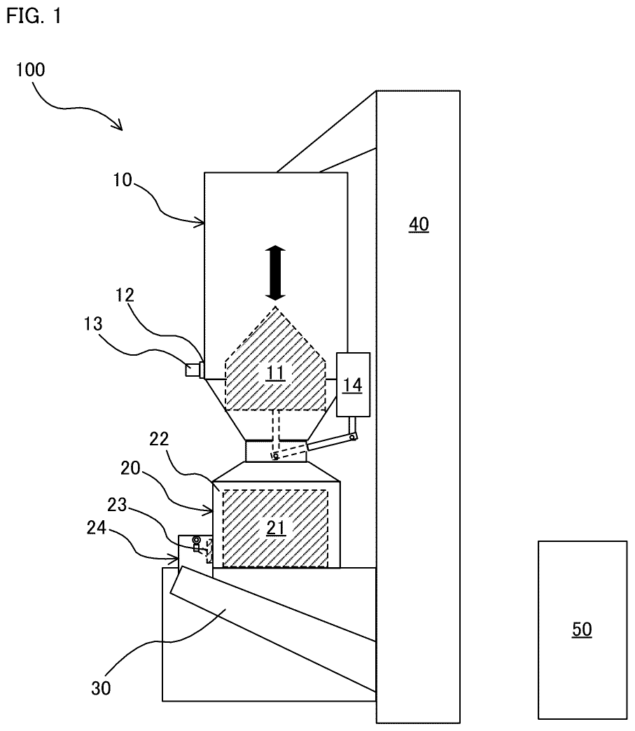

FIG. 1 illustrates a schematic configuration diagram of a rice milling machine 100 of the present embodiment. As illustrated, the rice milling machine 100 has at least a rice milling unit 20 that mills rice and a rice milling tank 10 that is provided above the rice milling unit 20 and can store rice, and a rice milling chamber 22 and a rice milling roll 21 are arranged in the rice milling unit 20.

Furthermore, a resistance plate 23 is arranged in a milled rice discharge port 24 of the rice milling unit 20, and discharged rice is carried to an elevating machine 40 via a grain screen 30. Rice is then supplied from the elevating machine 40 to the rice milling tank 10 and stored therein. The rice milling tank 10 is provided with a flow rate control valve 11 that can adjust a supply amount of rice to the rice milling unit 20 by vertical motion inside the rice milling tank 10 as a rice flow rate control mechanism and an optical flow rate detection unit 13 that is provided to a wall of the rice milling tank 10 and can determine the flow rate of rice flowing between the wall and the flow rate control valve 11.

Further, the rice milling tank 10 is provided with a driving cylinder 14 that is a driving source of the flow rate control valve 11 described above and a flow rate observation window 12 through which the inside of the rice milling tank 10 can be viewed is provided to the wall to which the optical flow rate detection unit 13 described above is installed. Furthermore, a control unit 50 that can control at least the flow rate control mechanism of the rice milling machine 100 is provided integrally with or separately from the rice milling machine 100.

As described above, the rice milling tank 10 is provided with the flow rate observation window 12, light is emitted therefrom to rice inside, images of the rice are read by the optical flow rate detection unit 13, feature points of images are extracted from the read images, motion of the feature points is measured, and thereby the motion direction and the motion speed of the rice are calculated.

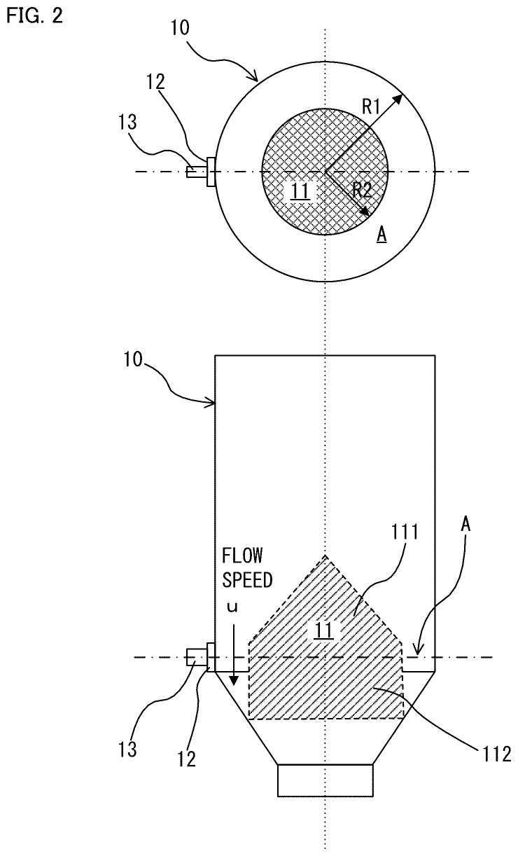

FIG. 2 illustrates sectional views of the rice milling tank 10 described above in planar view and side view. As described previously, the optical flow rate detection unit 13 that is provided to the wall of the rice milling tank 10 and can determine the flow rate of rice flowing between the wall and the flow rate control valve 11 is installed via the flow rate observation window 12.

Further, the flow rate control valve 11 of the present embodiment is formed of a conical part 111 and a columnar part 112 formed below the conical part 111, and stored rice flows down around the flow rate control valve 11 (the part A of FIG. 2). Accordingly, the optical flow rate detection unit 13 can determine the flow rate of rice flowing between the wall of the rice milling tank 10 and the columnar part 112 of the flow rate control valve 11 (the dash-dotted line in FIG. 2).

The stored rice flows down in the part A of FIG. 2, and the flow speed u (m/s) thereof is measured by the optical flow rate detection unit 13. Further, since the area of the part A (m²) is found based on the inner diameter R1 of the rice milling tank 10 and the outer diameter R2 of the flow rate control valve 11, the rice flow rate Q (m 3 /s) is calculated by multiplying this area (m²) by the flow speed u (m/s).

Note that the shape of the flow rate control valve 11 is not necessarily limited to the illustrated shape, however, when the rice milling tank 10 is cylindrical and the shape of the flow rate control valve 11 is bullet-shaped as illustrated, the stored rice is allowed to flow down homogeneously along the inner wall surface of the rice milling tank 10.

Further, although the optical flow rate detection unit 13 and the flow rate observation window 12 are provided at one portion in the rice milling tank 10 in the present embodiment, there may be a plurality of optical flow rate detection units 13 and flow rate observation windows 12, and these optical flow rate detection units 13 and flow rate observation windows 12 may be provided at multiple portions. Accordingly, when a flow of rice is obstructed for some reason, such as adhesion of rice bran to a part of the flow rate control valve 11 or bridging of rice near the flow rate control valve 11, the obstruction to the flow of rice can be found early from the detected data from the optical flow rate detection unit 13 provided at multiple portions.

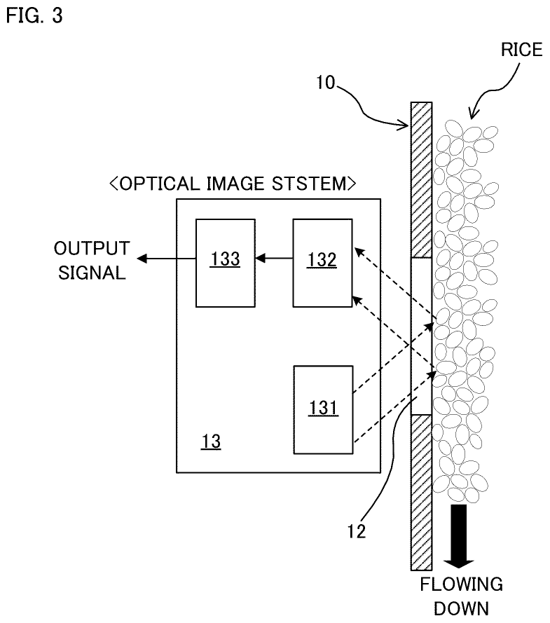

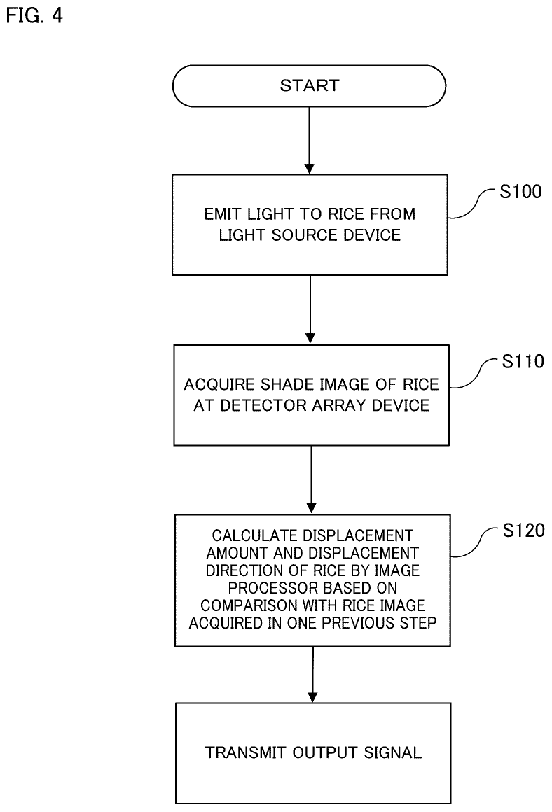

Next, the optical flow rate detection unit 13 will be described. As a detection configuration of the optical flow rate detection unit 13, FIG. 3 illustrates a detection configuration with an optical image system, and FIG. 4 illustrates the detection flowchart thereof.

That is, the optical flow rate detection unit 13 in an optical image detection system includes at least a light source device 131, a detector array device 132, and an image processor 133. Further, light is emitted to rice via the flow rate observation window 12 from the light source device 131 formed of an LED lamp or the like (S100), a shade pattern image of the rice is acquired at the detector array device 132 in the specular reflection direction (S110), and the displacement amount and the displacement direction of the rice can be calculated by the image processor 133 based on comparison with the rice image acquired in one previous step (S120).

Note that there is also a method in which a vertical cavity surface emitting laser (VCSEL) is used in the light source device 131 described above to emit laser to rice and the detector array device 132 acquires images of generated laser speckles. In such a case, the detector array device 132 can be arranged perpendicular to the detection surface.

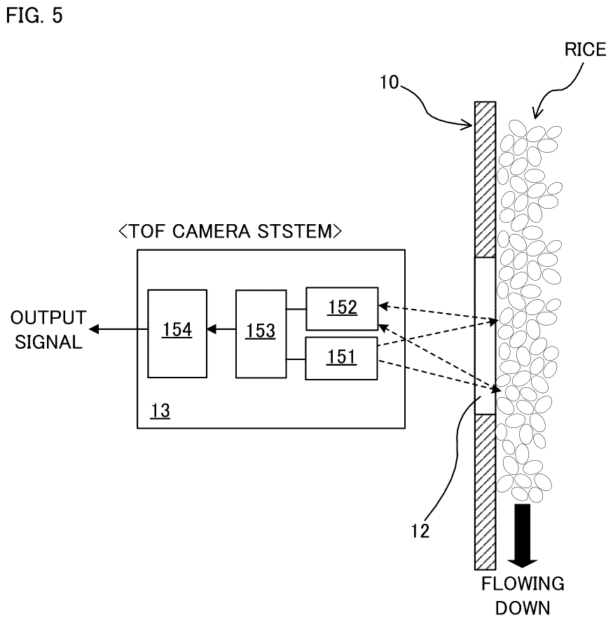

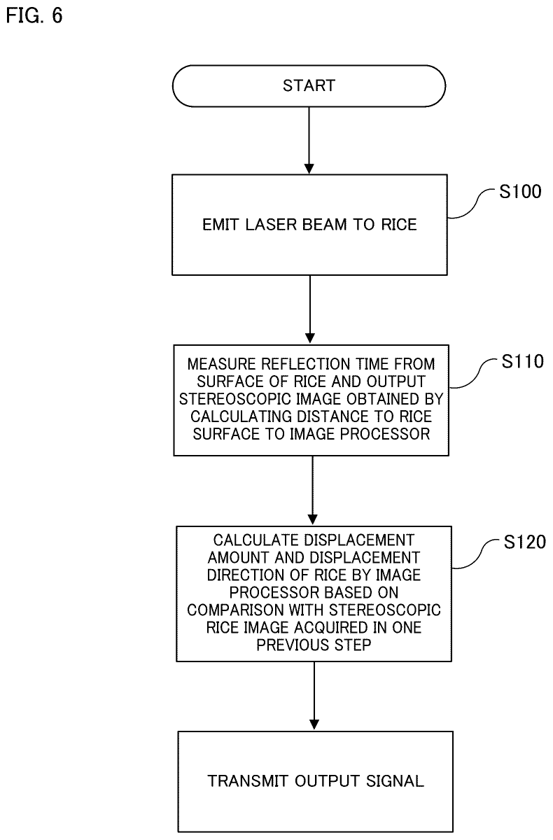

Next, another embodiment of the optical flow rate detection unit 13 will be described. FIG. 5 illustrates a detection configuration with a time of flight (TOF) camera system as a detection configuration of the optical flow rate detection unit 13, and FIG. 6 illustrates the detection flowchart thereof.

That is, the optical flow rate detection unit 13 in the TOF camera system includes at least a light source device 151, a detector array device 152, a TOF processor 153, and an image processor 154. Further, a laser beam is emitted to rice via the flow rate observation window 12 from the light source device 151 (S100 ), a reflection time from the surface of the rice is measured in the detector array device 152 and the TOF processor 153, and a stereoscopic image obtained by calculating the distance to the surface of the rice is output to the image processor 154 (S110 ). Furthermore, in the image processor 154, the displacement amount and the displacement direction of the rice can be calculated based on comparison with the rice stereoscopic image acquired in one previous step (S120).

According to the TOF camera system described above, since a laser beam is emitted substantially perpendicularly to rice, the effect such as specular reflection at the flow rate observation window 12 can be significantly reduced. Further, since this system does not utilize the intensity level of a laser beam, even when the flow rate observation window 12 is slightly dirty, the above effect can be avoided by increasing the output of the laser beam.

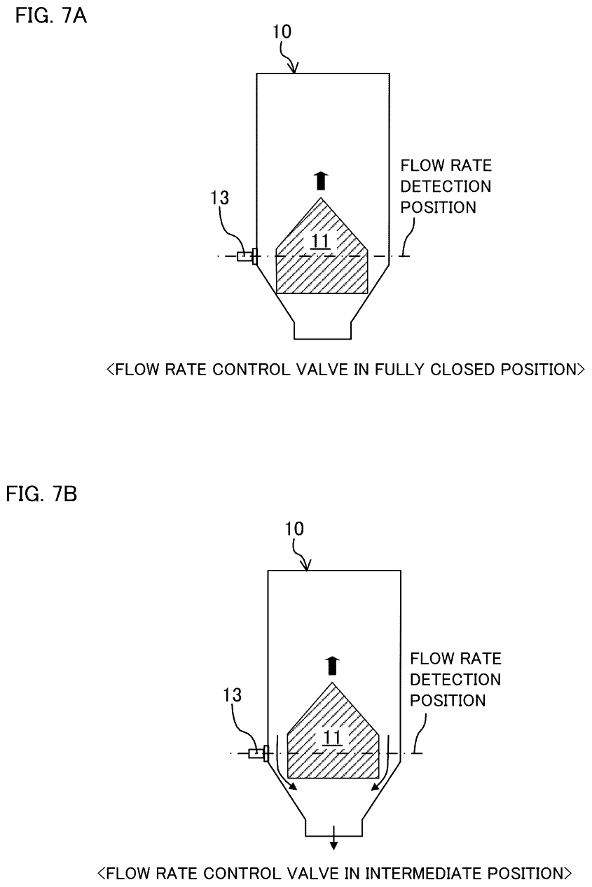

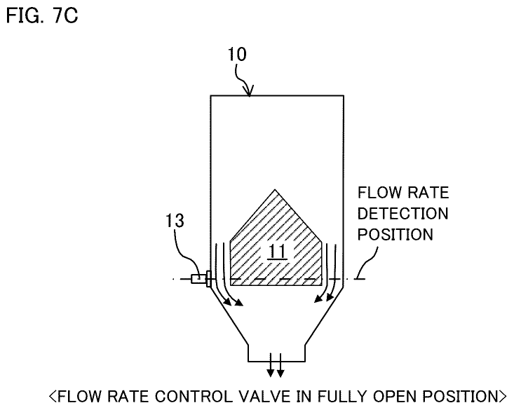

Next, the control configuration of the flow rate control valve 11 will be described. As described above, the control unit 50 that can control at least the flow rate control mechanism of the rice milling machine 100 is provided integrally with or separately from the rice milling machine 100, and FIG. 7A to FIG. 7C illustrate a motion form of the flow rate control valve 11 forming the flow rate control mechanism.

FIG. 7A illustrates a state where the flow rate control valve 11 is in a fully closed position, FIG. 7B illustrates a state where the flow rate control valve 11 is in an intermediate position, FIG. 7C illustrates a state where the flow rate control valve 11 is in a fully open position, and it is possible for the control unit 50 to move the flow rate control valve 11 upward or downward in order to ensure a necessary flow rate based on detected data from the optical flow rate detection unit 13.

As illustrated in FIG. 7A to FIG. 7C, in the present embodiment, because the flow rate detection position determined by the optical flow rate detection unit 13 is at the columnar part 112 of the flow rate control valve 11, the gap in the flow channel of rice at the flow rate detection position remains constant even when the flow rate control valve 11 is moved vertically. Accordingly, the rice flow rate can be stably determined.

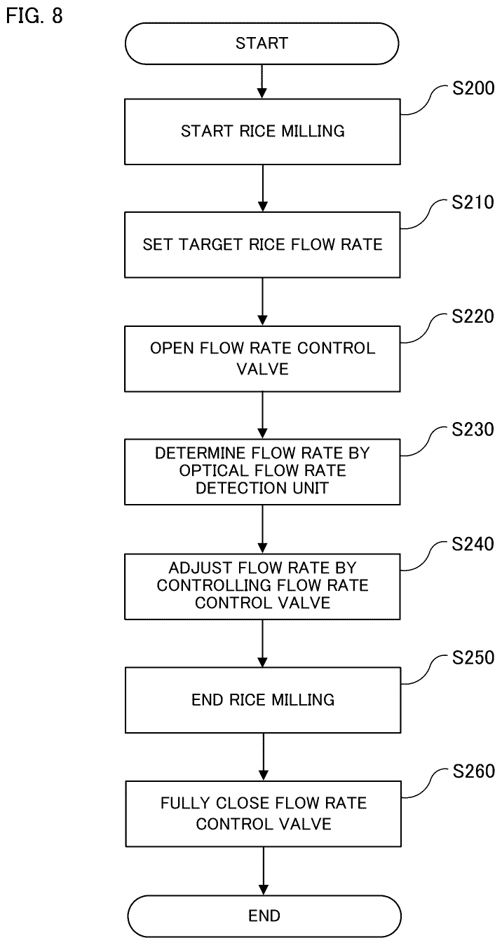

FIG. 8 illustrates a control configuration of the flow rate control mechanism in the present embodiment in a flowchart. As illustrated, rice milling in the rice milling machine 100 is started (S200), and a target flow rate of rice into the rice milling unit 20 is set (S210). Next, the flow rate control valve 11 is opened (S220), and the flow rate of rice is determined by the optical flow rate detection unit 13(S230 ). Then, based on the detected data from the optical flow rate detection unit 13, the flow rate is adjusted to reach the target flow rate of rice while the flow rate control valve 11 is moved vertically (S240). If the rice milling ends (S250), the flow rate control valve 11 is fully closed (S260), and all the control ends.

### Other Embodiments

The flow rate control mechanism of the rice milling machine of the embodiments has been described above, the present invention is not necessarily limited to the embodiments described above, and various modifications described below are possible.

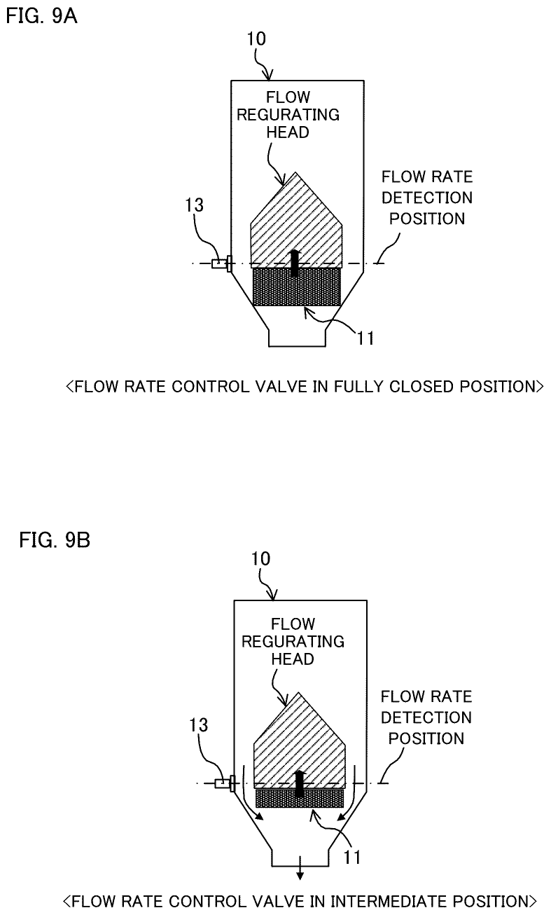

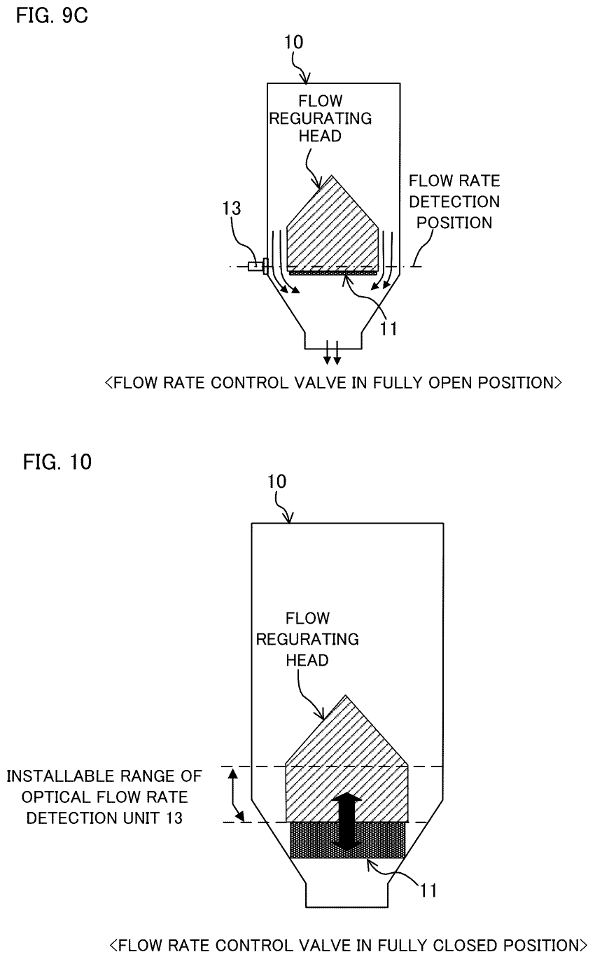

The flow rate control valve 11 of the above embodiment is moved vertically with the conical part 111 and the columnar part 112 being formed integrally as illustrated in FIG. 7A to FIG. 7C. As illustrated in FIG. 9A to FIG. 9C, however, it is also possible that a flow regulating head formed of a conical part and a cylindrical part is arranged in and fixed to the rice milling tank 10, a cylindrical or columnar flow rate control valve 11 is configured to enter and exit from the cylindrical part of the flow regulating head described above, and thereby the flow rate of rice is adjusted. With such a configuration, the load on the flow rate control valve 11 during operation can be significantly reduced. Note that, as with the embodiment illustrated in FIG. 10, the optical flow rate detection unit 13 can be provided not only to the vertical wall of the rice milling tank 10 but also to an inclined wall surface thereof as long as the wall is in a range having a constant cross section through which rice flows down (as illustrated in FIG. 10, “installable range of optical flow rate detection unit 13”) regardless of the operating state of the flow rate control valve 11.

Further, the flow rate control mechanism of the rice milling machine of the present invention is not limited to the above embodiments and can be applied to other types of rice milling machines or the like such as a horizontal friction-type rice milling machine or a rice polisher that polishes rice, and this enables efficient adjustment of the flow rate of rice.

Several embodiments of the present invention have been described above, the embodiments of the invention described above are intended to facilitate understanding of the present invention and not intended to limit the present invention. The present invention may be changed or improved without departing from the spirit thereof, and the equivalents thereof are included in the present invention. Further, some of components recited in the claims and described in the specification can be combined or omitted as long as at least a part of the problem described above can be solved or at least a part of the advantageous effect is achieved.

### List of Reference Symbols

10 rice milling tank
11 flow rate control valve
12 flow rate observation window
13 optical flow rate detection unit
14 driving cylinder
20 rice milling unit
21 rice milling roll
22 rice milling chamber
23 resistance plate
24 milled rice discharge port
30 grain screen
40 elevating machine
50 control unit
100 rice milling machine
111 conical part
112 columnar part
131 light source device
132 detector array device
133 image processor
151 light source device
152 detector array device
153 TOF processor
154 image processor

1: A flow rate control mechanism of a rice milling machine, the flow rate control mechanism comprising:
a rice milling unit configured to mill rice; and
a rice milling tank provided above the rice milling unit and configured to store rice,
wherein the rice milling tank includes
a flow rate control valve configured to adjust a supply amount of rice to the rice milling unit by being moved vertically in the rice milling tank, and
an optical flow rate detection unit provided to a wall of the rice milling tank and configured to determine a flow rate of rice flowing between the wall and the flow rate control valve.

2: The flow rate control mechanism of the rice milling machine according to claim 1 further comprising a control unit configured to control the flow rate control valve,
wherein the control unit is configured to move the flow rate control valve upward or downward based on detection data from the optical flow rate detection unit.

3: The flow rate control mechanism of the rice milling machine according to claim 1,
wherein the flow rate control valve includes a conical part and a columnar part formed below the conical part, and
wherein the optical flow rate detection unit determines a flow rate of rice flowing between the wall of the rice milling tank and the columnar part of the flow rate control valve.

4: The flow rate control mechanism of the rice milling machine according to claim 1, wherein the optical flow rate detection unit is configured to output a displacement amount and a displacement direction of rice from continuous images of the rice acquired by using a vertical cavity surface emitting laser.

5: The flow rate control mechanism of the rice milling machine according to claim 3, wherein the optical flow rate detection unit is configured to output a displacement amount and a displacement direction of rice from continuous images of the rice acquired by using a vertical cavity surface emitting laser.

6: The flow rate control mechanism of the rice milling machine according to claim 1, wherein the optical flow rate detection unit is configured to output a displacement amount and a displacement direction of rice from continuous images of the rice acquired by using a TOF camera.

7: The flow rate control mechanism of the rice milling machine according to claim 3, wherein the optical flow rate detection unit is configured to output a displacement amount and a displacement direction of rice from continuous images of the rice acquired by using a TOF camera.
